(19) United States
(12) Patent Application Publication
(10) Pub. No.: US 2015/0210402 A1
(43) Pub. Date: Jul. 30, 2015

(54) PROPULSION DEVICE USING FLUID FLOW

(71) Applicant: Nak Hwe Kim, Guje (KR)

(72) Inventor: Nak Hwe Kim, Guje (KR)

(21) Appl. No.: 14/418,950

(22) PCT Filed: Aug. 1, 2013
(86) PCT No.: PCT/KR2013/006933

§ 371 Date: Feb. 1, 2015

(30) Foreign Application Priority Data
Aug. 3, 2012 (KR) 10-2012-0085335

(51) Int. Cl. B64D 27/02; B64D 33/00; B64D 29/02

(52) U.S. Cl. CPC B64D 27/02; B64D 29/02; B64D 33/00

(57) ABSTRACT

A propulsion device includes: a fluid storage unit including a first inlet line, a first outlet line, a fluid storage surface disposed between the first inlet line and the first outlet line and having a downward curvature, and a barrier wall formed at one side of the fluid storage surface; a fluid flow unit including a second inlet line, a second outlet line having one end connected to the first outlet line and being tilted backward, and a fluid flow surface disposed between the second inlet line and the second outlet line and having a downward curvature to form a fluid flow space; and a fluid supply unit including a third inlet line disposed between the first inlet line and the second inlet line, wherein fluid introduced through the third inlet line is mixed with fluid that flows from the fluid storage unit to the fluid flow unit.

### TECHNICAL FIELD

The present invention relates to a propulsion device, and more particularly to a device for discharging the vortex flow to outside that is generated on a surface of the device and for increasing the amount of fluid flow incoming through a fluid supply unit to increase the vortex flow generation and discharge speed of the vortex flow, to thereby increase the propulsion and reduce the drag of the system equipped with the device.

### BACKGROUND TECHINQUE

Bernoulli's principle is a law which quantitatively shows the relationship among the velocity, pressure and height of flowing fluid, and is derived from the fact that the sum of the potential energy and the kinetic energy of flowing fluid is constant if the fluid is an ideal fluid, i.e., the fluid has no viscosity and is incompressible.

Bernoulli's principle states that, for an inviscid flow, an increase in the speed of the fluid occurs simultaneously with a decrease in pressure and vice versa. In modern everyday life, there are many observations that can be successfully explained by Bernoulli's principle.

As a typical example of the application of Bernoulli's principle, FIG. 1 shows a cross sectional view of an aircraft wing, wherein the wing has a bottom surface formed in the shape of a straight line and a top surface formed in the shape of a curve that is concave upwards.

As depicted, the same fluid flows from a first point where the fluid hits the wing to a last point where the fluid gathers again. In order to reach the last point at the same time, the fluid on the top surface of the wing has to move a relatively longer distance than the fluid on the bottom surface of the wing so that the fluid on the top surface of the wing has a higher speed than the fluid on the bottom surface.

Then, due to the difference in velocity, the pressure on the top surface of the wing will be relatively lower than the pressure on the bottom surface, generating lift on the aircraft.

However, a conventional aircraft wing using Bernoulli's principle as discussed above relates to the generation of lift that enables the aircraft to lift off the ground, but does not generate the thrust on the transfer means, such as vehicles and ships, except aircraft.

FIG. 2 shows a cavity flow in a flow station, illustrating a vortex formed in the cavity.

FIG. 3a shows an unstable vortex flow generated in the corner of a backward facing step, where the freestream approaches along a direction normal to the edge of the step. FIG. 3b shows a stable vortex flow generated in the corner of a backward facing step, where the freestream approaches at an intended angle relative to the normal to the edge of the step.

### Technical Problem

The present invention is derived to resolve the problems of the prior art as discussed above and has an object to provide a propulsion device using fluid flow, where the device mixes the vortex flow generated in a flow storage unit with the fluid introduced into a flow supply unit, to thereby quickly discharge the vortex flow and enhance the propulsion of a system equipped with the device.

### The Task Solution Means

In order to achieve the above and any other objects of the present invention,

according to one aspect of the present invention, there is provided a propulsion device using fluid flow, which comprises: a fluid storage unit 10, in which a downwardly curved fluid storage surface 13 is formed between a first inlet line 11 at the leading edge side, through which fluid is introduced, and a first outlet line 12 at a trailing edge side, through which fluid is discharged, such that a fluid storage space 14 is defined by the fluid storage surface 13, and a barrier wall 15 is formed at one side of the fluid storage surface 13;

a fluid flow section 20, where a second inlet line 21 is connected to the end of the first inlet line 11, a second outlet line 22 is connected to the end of the first outlet line 12, and a downwardly curved fluid flow surface 23 is formed between the second inlet line 21 and the second outlet line 22, such that a fluid flow space 24 is defined by the fluid flow surface 23, wherein a distance between the second inlet line 21 and the second outlet line 22 gradually decreases as it progresses outwardly and the portion of the fluid flow surface 23 adjacent to the second outlet line 22 becomes gradually flattened as it progresses outwardly; and

a fluid supply unit 30 for receiving fluid through a third inlet line 31, the fluid supply unit 30 is formed by cutting a portion of the leading edge side of the device between the first inlet line 11 meets the second inlet line 21 and the fluid received through the third inlet line 31 is mixed with the vortex that moves from the fluid storage unit 10 to the fluid flow section 20.

The fluid introduced into the fluid supply unit 30 flows toward the fluid flow space 24 of the fluid flow section 20 and rotates in the direction opposite to the vortex flow that moves from the fluid storage unit 10 to the fluid flow section 20 and exits the fluid flow section 20.

To increase the amount of flow into the fluid supply unit 30, the length of the third inlet line 31 can be increased by cutting away a larger portion of the leading edge side the device along the direction of the second inlet line 21.

### EFFECT OF INVENTION

The above-described configuration of the propulsion device of the present invention in view of the task solution means is advantageous in that the fluid introduced into the fluid storage space and the fluid flow space turns into a vortex flow to increase pressure, the fluid flow space gradually narrows as it progresses toward an end of the fluid flow surface so as to quickly discharge the vortex flow at the end of the fluid flow surface, and the shape of the fluid flow surface is formed to be gradually flattened as it progresses toward the end of the fluid flow surface so as to increase vortex flow velocity and improve the propulsion and thrust of transportation means equipped with the propulsion device.

Furthermore, the flow introduced through the fluid supply unit is mixed with the vortex flow that moves from the fluid storage unit to the fluid flow section, increasing the amount of fluid introduced into the device and the speed of the flow in the device to thereby enhance the thrust of the transportation means.

The amount of fluid into the device and the speed of the flow in the device can be controlled by varying the lengths of the fluid storage unit and the fluid flow surface along the spanwise direction. Also, depending on the freestream speed, the curvature of the fluid flow surface and the tilt angle of the fluid flow surface relative to the freestream can be adjusted so that the amount fluid introduced into the device and the speed of the flow in the device can be increased to thereby enhance the thrust of the transportation means.

### BRIEF DESCRIPTION OF DRAWINGS

FIG. 1 shows a cross sectional view an aircraft wing.

FIG. 2 shows a cavity flow generated in a flow station.

FIG. 3a shows an unstable vortex flow generated in the corner of a backward facing step, where the freestream approaches along a direction normal to the normal to the edge of the step.

FIG. 3b shows a stable vortex flow generated in the corner of a backward facing step, where the freestream approaches at an intended angle relative to the normal to the edge of the step.

FIG. 4 shows a perspective top rear view a propulsion device according to one embodiment of the present invention.

FIG. 5a shows a front view of the device in FIG. 4.

FIGS. 6a-6c are sectional views taken along the directions A-A, C-C, and B-B of FIG. 5, respectively.

FIGS. 7a-7c show the top views of the device in FIG. 4, illustrating the flow directions in the device.

FIGS. 8a-8b show cross sectional views of the device taken along the direction D-D in FIG. 4, where the barrier walls have different curvatures according to embodiments of the present invention.

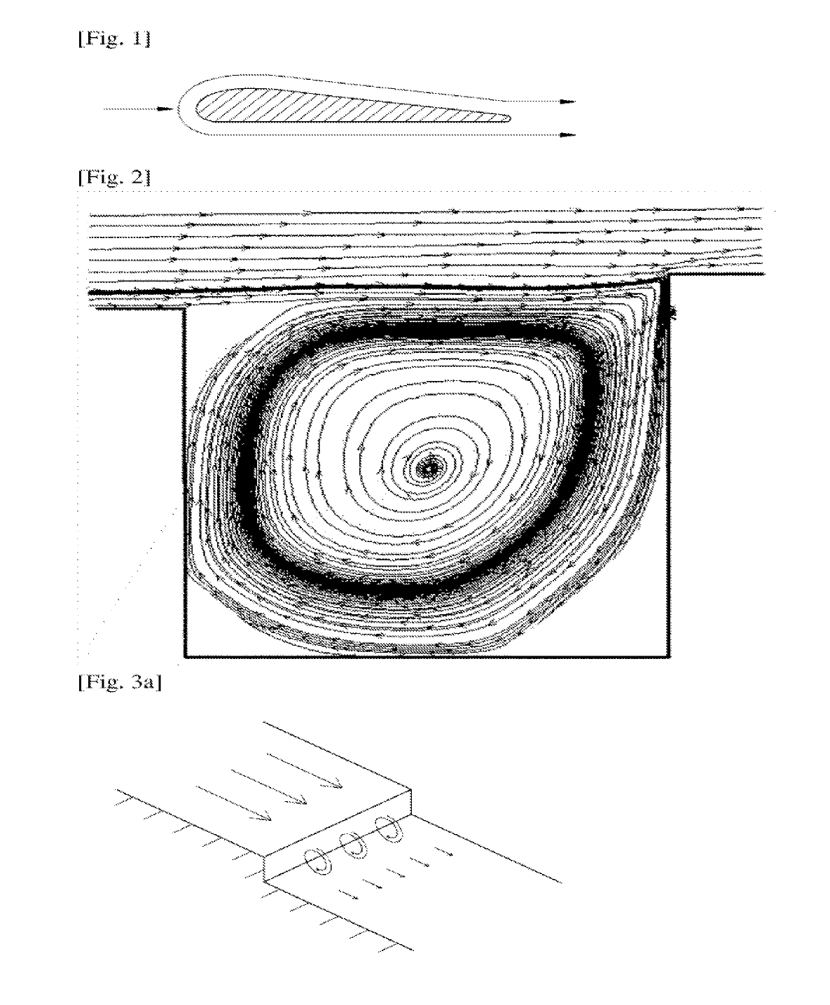

### BEST MODE FOR CARRYING OUT INVENTION

Hereinafter, preferred embodiments of the present invention will be described in detail with reference to the accompanying drawings.

A propulsion device according to the present invention may be attached to an outside frame section of a transfer means that is subject to friction with fluid and propelled by a propulsion system. In particular, the propulsion devices according to the present invention may be attached to the transfer means, such as a ship, a submarine, an aircraft, a vehicle or the like, so as to increase the thrust of the transfer means.

For instance, in embodiments, two propulsion devices shown in FIG. 4 may be attached symmetrically with respect to the centerline of the fuselage of an airplane.

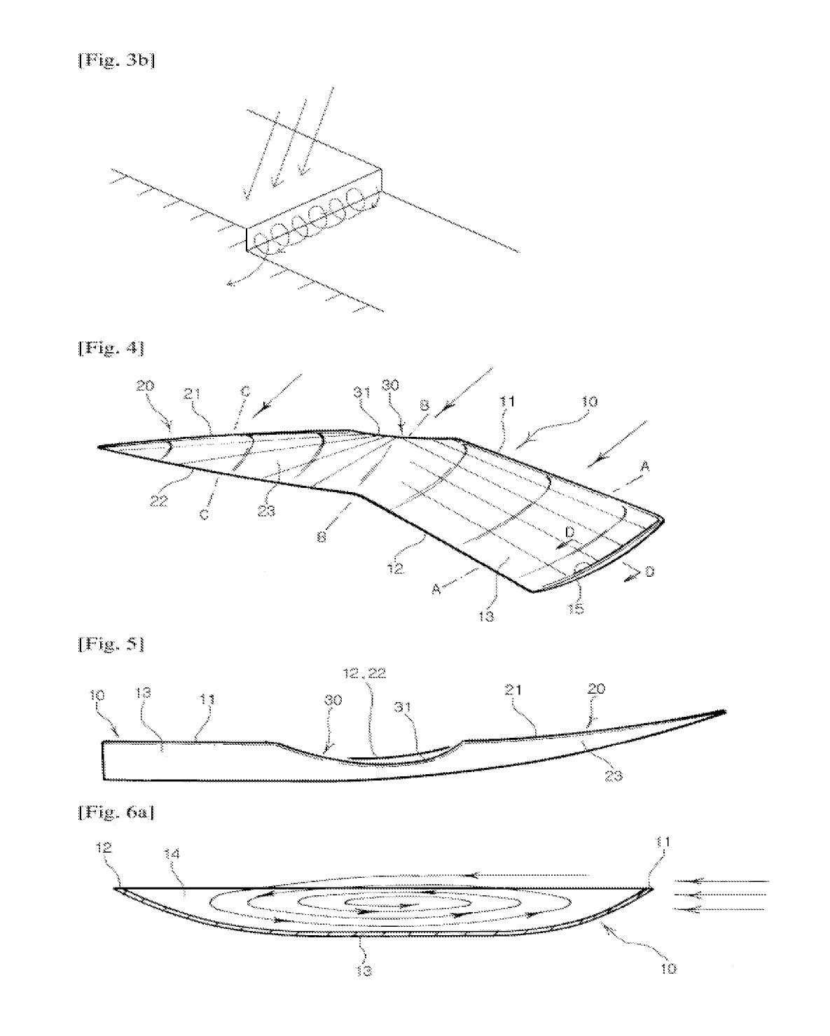

FIGS. 4-8b show embodiments of the propulsion device, where the propulsion device includes a fluid storage unit 10, a fluid flow section 20, and a fluid supply unit 30.

As depicted in FIGS. 4-6a, a fluid storage unit 10 has a shape of an approximately trapezoid and positioned at one side of the propulsion device. A first inlet line 11 is formed at the leading edge of the fluid storage unit 10 to face the freestream and the first inlet line 11 has one end that is recessed backward. A first outlet line 12 is formed at the rear portion of the first inlet line 11 where the fluid is discharged.

A fluid storage surface 13 is formed to be curved downwards between the first inlet line 11 and the first outlet line 12, and a fluid storage space 14 is formed on (or defined by) the fluid storage surface 13.

Furthermore, a barrier wall 15 is formed at one side of the fluid storage surface 13 and between one side end of the first inlet line 11 and one side end of the first outlet line 12, where the barrier wall 15 has a curved surface in embodiments.

In order to increase the amount of fluid that is to be introduced into the fluid storage space 14, the length of the first inlet line 11 and the first outlet line 12 may be increased such that the length of the fluid storage surface 13 may be increased in the spanwise direction. Accordingly, the fluid that is collected in the fluid storage unit 10 may be sent to the fluid flow section 20 more rapidly.

As shown in FIGS. 4-6b, the fluid flow section 20 has a shape of an approximately triangle and positioned at the other side of the propulsion device. A second inlet line 21 is formed at a leading edge side of the fluid flow section 20 where a fluid is introduced, while the second inlet line 21 has one side end that faces one end of the first outlet line 11 and the other side end that is recessed backward.

A second outlet line 22 is formed at the rear portion of the second inlet line 21 where the fluid is discharged. The second outlet line 22 has one side end that is connected to the first outlet line 12 and the other side end that is recessed backward while being connected to one end of the second inlet line 21.

The fluid flow surface 23 is formed between the second inlet line 21 and the second outlet line 22, where the fluid flow surface 23 is curved downwards so that its cross section has a streamline shape. A fluid flow space 24 is formed on (or defined by) the fluid flow surface 23.

The portion between the second inlet line 21 and the second outlet line 22, which forms the fluid flow surface 23, becomes gradually narrow as it progresses outwardly, and the portion of the fluid flow surface 23 adjacent to the second outlet line 22 is gradually flattened as it progresses outwardly. Accordingly, the vortex flow that flows along the fluid flow surface 23 towards the outside may be collected at the end portion of the fluid flow surface 23 and then discharged outside.

In order to increase the speed of fluid in the fluid flow space 24, the length of the second inlet line 21 and the second outlet line 22 may be increased so that the length of the fluid flow surface 23 in the spanwise direction may be increased. Accordingly, the amount of the fluid that is discharged from the fluid flow unit 20 and the speed of fluid in the fluid flow unit 20 may be increased.

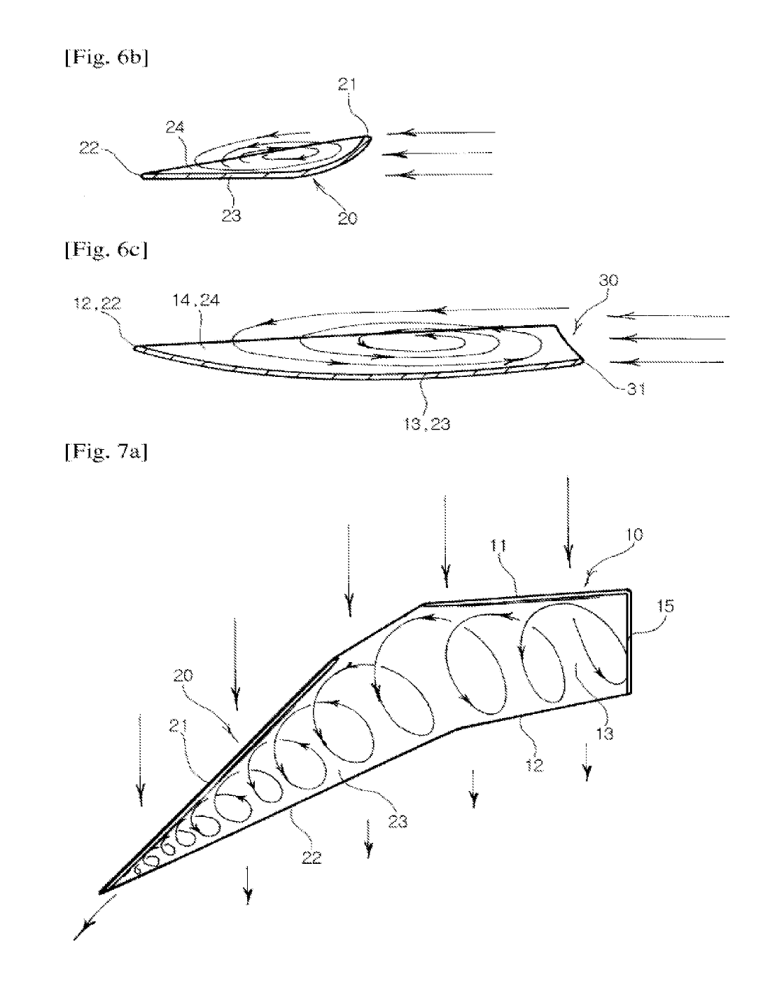

As depicted in FIGS. 6a-6b, in the case where the freestream, which comes into contact with the first inlet line 11 and the second inlet line 21, is introduced into the fluid storage space 14 and the fluid flow space 24 at a high speed, the amount of the fluid that is introduced into the fluid flow space 24 may be increased by bending more downwardly a portion of the fluid flow surface 23 that is adjacent to the second inlet line 21.

That is, as the velocity of the freestream that comes into contact with the second inlet line 21 is increased, the curvature of the fluid flow surface 23 is increased downwardly.

Further, in the case where the freestream, which comes into contact with the first inlet line 11 and the second inlet line 21, is introduced into the fluid storage space 14 and the fluid flow space 24 at a high speed, the amount of the fluid that is introduced into the fluid flow space 24 may be increased by increasing the tilt angle of the fluid flow surface 23 more backward.

That is, as the velocity of the freestream that comes into contact with the inlet lines 11, 21 is increased, the tilt angle of the fluid flow surface 23 is increased so that the fluid flow surface 23 is inclined further backward.

As depicted in FIGS. 4-6c, a portion where the first inlet line 11 meets the second inlet line 21 is cut away to form a third inlet line 31. The fluid introduced into the flow supply unit 30 through the third inlet line 31 is added to the fluid that flows from the fluid storage unit 10 to the fluid flow section 20.

The third inlet line 31 is skewed more towards the second inlet line 21 than the first inlet line 11, i.e., to form the fluid supply unit 30, the portion cut away from the fluid flow section 20 is larger than the portion cut away from the fluid storage unit 10. The fluid introduced into the fluid supply unit 30 flows toward the fluid flow section 20.

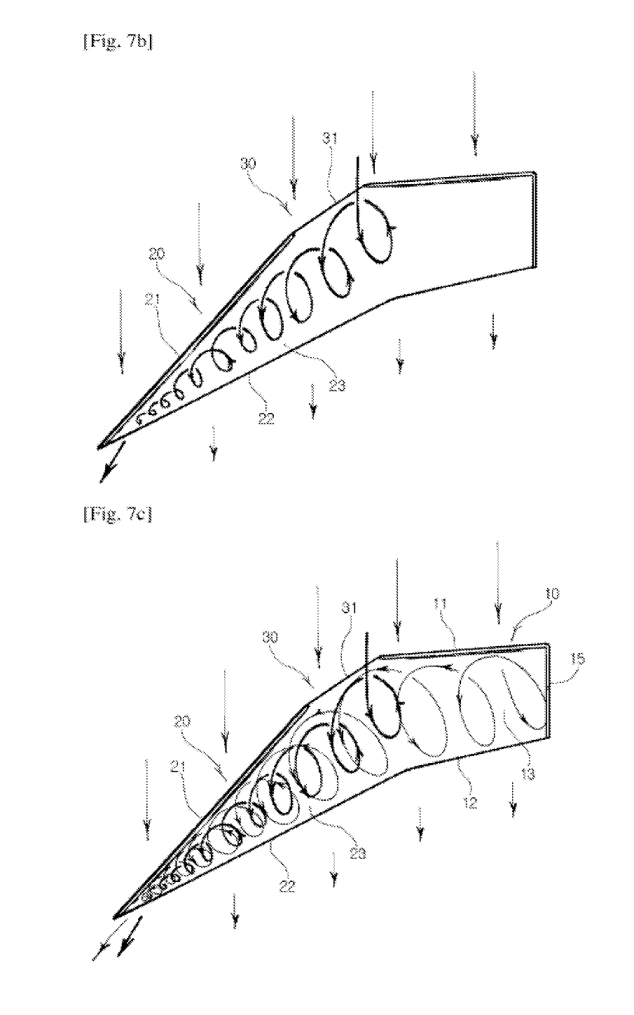

FIG. 7a-7c show top views of the device in FIG. 4, illustrating the fluid flowing in the device. For the purpose of illustration, FIG. 7a shows only the vortex flow that is generated in the fluid storage unit 10 and flows toward the fluid flow section 20 as the device proceeds forward. Likewise, FIG. 7b shows only the fluid that is introduced into the fluid supply unit 30, where the fluid flow becomes a vortex flow and proceeds toward the fluid flow section 20.

FIG. 7c shows how the vortex flow in FIG. 7a is mixed with the vortex flow in FIG. 7b as the device proceeds forward.

As shown in FIG. 7a, the fluid introduced into the fluid storage unit 10 arrives at the fluid storage space 14 and swirls in the counterclockwise direction seen from the barrier wall 15.

As depicted in FIG. 7b, the fluid introduced into the fluid supply unit 30 flows along the fluid storage surface 23 and swirls in the clockwise direction within the fluid flow space 24.

Thus, the vortex flow from the fluid storage unit 10 is mixed with the vortex flow from the fluid supply unit 30 to thereby increase the fluid flow speed in the fluid flow section 20 and the mixed flow finally exits the fluid flow section 20.

To increase the amount of fluid that is introduced into the fluid supply unit 30, the third inlet line 31 can be extended further toward the second inlet line 21, i.e., the portion cut away from the fluid flow section 20 may be increased.

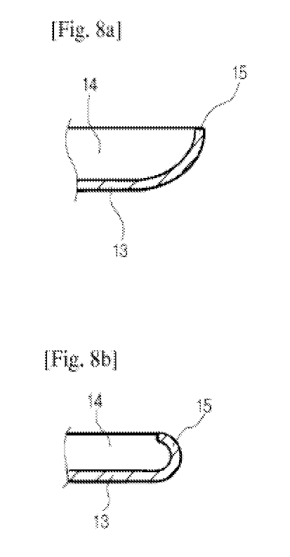

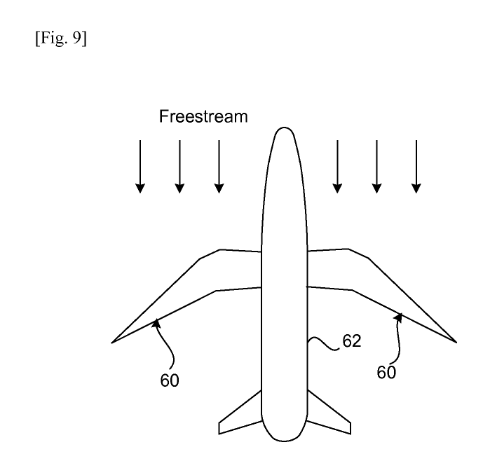

As depicted in FIGS. 8a and 8b, barrier wall 15 located on one side of the fluid storage unit 10 may be curved toward the fluid storage space 14 as the amount and speed of fluid introduced through the first inlet line 11 increases.

As the amount and speed of fluid introduced through the first inlet line 11 increases, the bottom portion of the barrier wall 15 is curved toward the fluid storage space 14.

Now, the operations and effect of the present invention as constructed above will be described in more detail.

A propulsion device according to the present invention is formed to an outside frame section of a transfer means such as ship, aircraft or the like, in the advancing direction of the transfer means.

As the transfer means equipped with the propulsion device moves forward, the fluid collides with the first inlet line 11 and the second inlet line 21, 41 and is introduced into the fluid storage space 14 and the fluid flow space 24.

The fluid introduced into the fluid storage space 14 and the fluid flow space turns into a vortex flow so that pressure applied to the fluid storage space 14 and the fluid flow space 24 increases according to Bernoulli's principle.

Also, in one embodiment, the vortex flow introduced into the fluid storage space 14 collides against the barrier wall 15 and then flows into the fluid flow space 24 so that the amount of the fluid may flow into the fluid flow space 24 can be increased.

In one embodiment, the fluid collides with the third inlet line 31 formed at the portion where the fluid storage unit 10 meets the fluid flow section 20 and is mixed with the vortex flow that flows from the flow storage space 14 to fluid flow space 24 and flows into the fluid flow space 24.

The fluid flow space 24 is formed on the fluid flow surface 23 and becomes gradually narrow as it progresses toward the tip portion of the fluid flow surface 23. Thus, the speed of the flow from the flow storage space 14 and the flow introduced through the second inlet line 21 and the third inlet line 31 increases as the flow proceeds toward the tip portion of the fluid flow surface 23 according to the Bernoulli's principle.

The second exit line 22 is gradually flattened as it proceeds toward the tip portion of the fluid flow surface 23 so that, according to the Bernoulli's principle, the speed of the fluid increases as it moves toward the end portion of the fluid flow surface 23, to thereby increase the propulsion and thrust of the transfer means equipped with the device.

By increasing the length of the fluid storage surface 13 in the spanwise direction and/or the length of the fluid flow surface 23 in the spanwise direction and/or the length of the third inlet line 31 of the fluid supply unit 30 toward the fluid flow surface 23, the amount of fluid introduced into the fluid storage space 14 and the fluid flow space 24 is increased. Also, the amount and speed of fluid that flows along the fluid flow surface 23 increased to thereby increase the thrust of the transfer means.

In embodiment, when the freestream that collides against the front surface of the propulsion device increases as the speed of the transfer means increases, the speed of the fluid discharged along the fluid flow surface 23 may be increased by downwardly increasing the curvature of the portion of the fluid flow surface 23 near the second inlet line 21 or by increasing the tilt angle of the fluid flow surface 23, to thereby increase the thrust of the transfer means.

While the invention has been described with reference to the above embodiments thereof, the invention is not limited thereto. It will be understood by those of ordinary skill in the art that various changes in form and details may be made therein within the invention.

What is claimed is:

1. A propulsion device, comprising:
a fluid storage unit including a first inlet line disposed on a leading edge side to introduce fluid therethrough, a first outlet line disposed on a trailing edge side to discharge fluid threthrough, a fluid storage surface that is disposed between the first inlet line and the first outlet line and having a downward curvature, and a barrier wall formed at one side of the fluid storage surface;
a fluid flow unit including a second inlet line disposed on a leading edge side, a second outlet line having one end connected to an end of the first outlet line and being tilted backward, and a fluid flow surface disposed between the second inlet line and the second outlet line and having a downward curvature to form a fluid flow space, wherein a distance between the second inlet line and the second outlet line becomes shorter as it progresses toward a tip of the device and wherein a portion of the fluid flow surface near the second outlet line becomes gradually flattened as it progresses toward the tip of the device; and
a fluid supply unit including a third inlet line disposed between the first inlet line and the second inlet line, wherein fluid introduced through the third inlet line is mixed with fluid that flows from the fluid storage unit to the fluid flow unit.

2. A propulsion device as recited in claim 1, wherein the fluid introduced through the third inlet line flows into the fluid flow space, swirls in a same direction as the fluid that flows from the fluid storage unit to the fluid flow, and exits the fluid flow unit.

3. A propulsion device as recited in claim 1, wherein an amount of fluid introduced through the third inlet line increases as the third inlet line is further elongated toward the second inlet line.

4. A propulsion device as recited in claim 1, wherein an amount of fluid introduced into the fluid storage space increases as a dimension of the flow storage surface is increased in a spanwise direction of the device.

5. A propulsion device as recited in claim 1, wherein a speed of fluid in the fluid flow space increases as a dimension of the fluid flow surface is increased in a spanwise direction of the device.

6. A propulsion device as recited in claim 1, wherein a downward curvature of a portion of the fluid flow surface near the second inlet line is increased as a speed of a freestream facing the first and second inlet lines increases.

7. A propulsion device as recited in claim 1, wherein a tilt angle of the fluid flow surface is increased as a speed of a freestream facing the first and second inlet lines increases.

8. A propulsion device as recited in claim 1, wherein the barrier wall is curved toward the fluid storage space as a speed of a freestream facing the first inlet line increases.
